(19) United States
(12) Patent Application Publication
(10) Pub. No.: US 2023/0360156 A1
(43) Pub. Date: Nov. 9, 2023

(54) REMOVING BIASES IN A PROCESS FOR RETAINING SERVICE PROVIDERS

(71) Applicant: LAST MINUTE JUSTICE LLC, Centreville, VA (US)

(72) Inventor: Suleiman PARACHA, Centreville, VA (US)

(21) Appl. No.: 18/021,771

(22) PCT Filed: Aug. 24, 2021
(86) PCT No.: PCT/US2021/047382

§ 371 Date: Feb. 16, 2023

Related U.S. Application Data
(60) Provisional application No. 63/069,391, filed on Aug. 24, 2020.

(51) Int. Cl. G06Q 50/18

(52) U.S. Cl. CPC G06Q 50/18

(57) ABSTRACT

A method for matching a client and a service provider includes receiving, from a client device associated with the client, a service request message indicating both a request for the service provider based on an occurrence of an event and multiple event details associated with the event. The method further includes generating a set of scrubbed event details comprising one or more event details of the multiple event details based on receiving the service request message. The personal identification information associated with the client may be unattainable from the set Of scrubbed event details. The method still further includes receiving, from a service provider device associated with the service provider, a service proposal based on transmitting the set of scrubbed event details. The method also includes transmitting, to the client device, the service proposal based on receiving the service proposal from the service provider.

### FIELD

Aspects of the present disclosure generally relate to a service provider retention process, and more particularly to protecting confidential information and reducing biases in a service provider retention process, while also observing protocols to preserve legal privileges, including but not limited to attorney-client privilege.

### BACKGROUND

In a conventional service provider retention process, a person in need of a service provider may engage a service provider based on a search, such as an Internet search, or a personal recommendation. The person in need of the service provider may be referred to as a client or a potential client. In some examples, an amount of time dedicated to the search may be limited due to resources available to the client. These resources may include time, money, knowledge, and/or a lack of search resources. For example, a potential client may only perform a limited Internet search via one service provider recommendation website. As another example, a potential client with an imminent court date may have a limited amount of time to find an appropriate service provider, such as an attorney specializing in a particular area of law. Additionally, a client may not properly identify or fully recognize the type of service provider or specialist who is specified to handle the service needed.

In some examples, a service provider may exploit various situations based on information provided by a potential client. Information, such as race, sex, age, education, religion, address, available resources, and/or other types of information may be exploited by the service provider. As an example, the service provider may increase a price associated with a service because the potential client has a limited amount of time before a scheduled court date. As another example, the service provider may increase a price associated with a service because the potential client lives in an affluent neighborhood. Service providers may also refuse to service clients, charge higher rates, or require larger retentions or deposits based on the perceived ethnicity, race, or gender of the client's name, accent if the discussion is in person or over the telephone (which can be used, for example, to identify sex and age), or based on the clients' residence in less desirable neighborhoods or cities. It may be desirable to reduce biases in a service provider retention process, such that the process may be normalized for all clients searching for a service provider. By normalizing the search process, normalization of service quality and charges will be more likely.

### SUMMARY

In one aspect of the present disclosure, a method for matching a client and a service provider by an online matching system is includes receiving, from a client device associated with the client, a service request message indicating both a request for the service provider based on an occurrence of an event and multiple event details associated with the event. One or more event details of the multiple event details may include personal identification information associated with the client. The method further includes generating a set of scrubbed event details comprising one or more event details of the multiple event details based on receiving the service request message. The personal identification information associated with the client may be unattainable from the set of scrubbed event details. The method still further includes receiving, from a service provider device associated with the service provider, a service proposal based on transmitting the set of scrubbed event details to the service provider device. The method also includes transmitting, to the client device, the service proposal based on receiving the service proposal from the service provider. The method further includes transmitting, to the service provider device, multiple event details based on receiving an acceptance message indicating acceptance of the service proposal, the acceptance message being received based on transmitting the service proposal.

Another aspect of the present disclosure is directed to an apparatus for matching a client and a service provider by an online matching system. The apparatus includes means for receiving, from a client device associated with the client, a service request message indicating both a request for the service provider based on an occurrence of an event and multiple event details associated with the event. One or more event details of the multiple event details may include personal identification information associated with the client. The apparatus further includes means for generating a set of scrubbed event details comprising one or more event details of the multiple event details based on receiving the service request message. The personal identification information associated with the client may be unattainable from the set of scrubbed event details. The apparatus still further includes means for receiving, from a service provider device associated with the service provider, a service proposal based on transmitting the set of scrubbed event details to the service provider device. The apparatus also includes means for transmitting, to the client device, the service proposal based on receiving the service proposal from the service provider. The apparatus further includes means for transmitting, to the service provider device, multiple event details based on receiving an acceptance message indicating acceptance of the service proposal, the acceptance message being received based on transmitting the service proposal.

In another aspect of the present disclosure, a non-transitory computer-readable medium with non-transitory program code recorded thereon for matching a client and a service provider by an online matching system is disclosed. The program code is executed by a processor and includes program code to receive, from a client device associated with the client, a service request message indicating both a request for the service provider based on an occurrence of an event and multiple event details associated with the event. One or more event details of the multiple event details may include personal identification information associated with the client. The program code further includes program code to generate a set of scrubbed event details comprising one or more event details of the multiple event details based on receiving the service request message. The personal identification information associated with the client may be unattainable from the set of scrubbed event details. The program code still further includes program code to receive, from a service provider device associated with the service provider, a service proposal based on transmitting the set of scrubbed event details to the service provider device. The program code also includes program code to transmit, to the client device, the service proposal based on receiving the service proposal from the service provider. The program code further includes program code to transmit, to the service provider device, multiple event details based on receiving an acceptance message indicating acceptance of the service proposal, the acceptance message being received based on transmitting the service proposal.

Another aspect of the present disclosure is directed to an apparatus for matching a client and a service provider at an online matching system. The apparatus includes a processor, a memory coupled with the processor, and instructions stored in the memory and operable, when executed by the processor, to cause the apparatus to receive, from a client device associated with the client, a service request message indicating both a request for the service provider based on an occurrence of an event and multiple event details associated with the event. One or more event details of the multiple event details may include personal identification information associated with the client. Execution of the instructions further cause the apparatus to generate a set of scrubbed event details comprising one or more event details of the multiple event details based on receiving the service request message. The personal identification information associated with the client may be unattainable from the set of scrubbed event details. Execution of the instructions also cause the apparatus to receive, from a service provider device associated with the service provider, a service proposal based on transmitting the set of scrubbed event details to the service provider device. Execution of the instructions still further cause the apparatus to transmit, to the client device, the service proposal based on receiving the service proposal from the service provider. Execution of the instructions also cause the apparatus to transmit, to the service provider device, multiple event details based on receiving an acceptance message indicating acceptance of the service proposal, the acceptance message being received based on transmitting the service proposal.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description, may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram illustrating an example of a network architecture for a matching system, in accordance with aspects of the present disclosure.

FIG. 2 is a timing diagram illustrating an example of a process for matching a service provider and a client, in accordance with aspects of the present disclosure.

FIG. 3 is a flow diagram illustrating an example of a process for registering a service provider at an online matching service, in accordance with aspects of the present disclosure.

FIG. 4 is a flow diagram illustrating an example of a process for registering a client at an online matching service, in accordance with aspects of the present disclosure.

FIG. 5 is a block diagram illustrating an example of a portal of an online matching service for providing incident details, in accordance with aspects of the present disclosure.

FIG. 6 is a block diagram illustrating an example of a process for matching a client and a service provider based on privatized information, in accordance with aspects of the present disclosure.

FIG. 7 is a block diagram illustrating an example of a communication device 700 that supports privatizing personal information in an online matching system, in accordance with various aspects of the present disclosure.

FIG. 8 is a flow diagram illustrating an example process performed, for example, by a communication device that supports privatizing personal information in an online matching system, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method which is practiced using other structure, functionality, or structure and functionality in addition to or other than the various aspects of the disclosure set forth. It should be understood that any aspect of the disclosure disclosed may be embodied by one or more elements of a claim.

Several aspects of systems and methods for retaining service providers will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using various types of technologies, aspects of the present disclosure are not limited to a particular generation-based computer systems and can be applied in newer or older generation-based computer systems.

In some cases, a person may need a service provider to assist with an event (e.g., an incident) experienced by, or caused by, the person. Such an event may include, but is not limited to, a violation of a law, an accident, or a medical event. In most cases, the person in need of the service provider may engage a service provider based on a search, such as an Internet search, or a personal recommendation. The person in need of the service provider may be referred to as a client or a potential client. In some examples, an amount of time dedicated to the search may be limited due to resources available to the client. These resources may include time, money, knowledge and/or a lack of search resources. For example, a potential client may only perform a limited Internet search via a service provider recommendation website, such as Yelp™. As another example, a potential client with an imminent court date may have a limited amount of time to find an appropriate service provider, such as an attorney specializing in a particular area of law. In some examples, a service provider may exploit various situations based on information provided by a potential client. Information, such as race, sex, age, education, religion, address, available resources, and/or other types of information may be exploited by the service provider. As an example, the service provider may increase a price associated with a service because the potential client has a limited amount of time before a scheduled court date. As another example, the service provider may increase a price associated with a service because the potential client lives in an affluent neighborhood. Service providers may also refuse to service clients, charge higher rates, or require larger retentions or deposits based on the perceived ethnicity, race, or gender of the client's name, accent if the discussion is in person or over the telephone (which can be used, for example, to identify sex and age), or based on the client's residence in less desirable neighborhoods or cities. These client qualities are rarely appropriate bases for service providers to use when deciding whether to provide service and what the fee should be.

As a specific example, a person may receive a traffic ticket for exceeding a posted speed limit. In this example, the event is a traffic violation. The traffic ticket may include various details regarding the event, such as one or more violated laws, a time of the event, a date of the event, the person's name, date of birth, driver's license number, vehicle make and model, license plate number, location of the event, and a court date. In some examples, the person may receive an additional court summons in the mail at a later time in response to the event. In some such examples, the person may engage in a search for a service provider (e.g., an attorney) based on receiving the summons. The search may be delayed or performed immediately. In either scenario, the person's search options may be limited. As discussed, the person may perform an Internet search via one or more websites. In such an example, the search results may be biased based on Internet Ads and other Internet marketing tactics. Such tactics are not limited to Internet searches and are applicable to other forms of media, such as print-ads, radio-ads, television-ads, etc. The person may also consult a general on-line or physical phone book to locate service providers. Additionally, or alternatively, the person may search for the service provider based on personal recommendations.

In all the above scenarios, regardless of the method used to search for a service provider, the person's search may be limited based on time and/or other resources. Additionally, the person must reach-out and engage a desired service provider once the desired service provider is identified. In such examples, the engagement process requires the person to provide details of the event and may also require the person to provide personal information. As discussed, the information provided by the person to the service provider may be associated with one or more implicit or explicit biases. In some examples, the personal information provided to the service provider may be associated with one or more explicit biases, such as age-based biases or gender-based biases. Additionally, the incident details and the general discussion with the service provider may be associated with one or more implicit biases, such as religious-biases, race-biases, socio-economic-biases. In some examples, the service provider may not be aware of such biases. Notwithstanding, such biases (e.g., implicit and/or explicit) may result in the service provider adjusting a price for an offered service or refusing to offer the service whatsoever.

As an example, the service provider may be biased toward or against people of a certain race or religion. In this example, the service provider may assume, or determine, a person's race or religion based on a name, an accent or writing style. As another example, the service provider may be biased toward or against people of a certain socio-economic background. In one example, the service provider may increase a price charged to people residing in affluent areas. In some examples, the service provider may assume, or determine, a person's socio-economic background based on the person's home address, event location, and/or car make and model. As such, the service provider may exploit the information provided by the person during the engagement process. This information may be exploited regardless of the communication medium used to engage the service provider. That is, the information may be exploited based on information gathered regardless of whether the service provider communicates with the person using text or audio.

Services offered by some service providers may not be associated with a fixed or standardized cost. For example, a cost of legal services may greatly vary between service providers in a same general location, such as within a same city. Therefore, consumers may fail to determine whether a quoted price is fair or a potential exploitation because the costs of legal services is not standardized. While obtaining multiple quotes for legal services could assist in understanding pricing, doing so can be time-consuming and still subject to error. Each consultation also requires the repetition of confidential information, including attorney-client protected information, which increases the risk that a key fact is provided with some but not other potential providers, further complicating a comparison of prices.

In some examples, the service provider's (e.g., attorney) biases may result in the service provider turning down a client or charging each client a different price for the same traffic infraction. The price may be based on a respective person's race, age, sex, car make and model, address, or other personal identification information. That is, the price of a service, or services offered by a service provider, may differ based personal identification information provided to the service provider during a service provider retention process. Therefore, it may be desirable to remove personal identification information in a service provider retention process, such that the process may be normalized for clients searching for a service provider.

Additionally, some conventional systems use a human-based system to match a client with a service provider. Still, such system may be limited to certain types of service providers that may not receive confidential or private information. As discussed, in some example, the event details may include confidential or private information that may be sensitive to a client and/or protected by one or more laws or regulations. In such examples, the human-based matching system may not be feasible because a human working in the human-based matching system may be unable to view the event details without compromising privilege. Therefore, it may be desirable to use an automated matching system to process sensitive information, such as confidential or private information, and/or information protected by one or more laws or regulations.

Aspects of the present disclosure generally relate to matching a client and a service provider at an online matching system. In some examples, the online matching system may receive, from a client device associated with the client, a service request message indicating both a request for the service provider based on an occurrence of an event and multiple event details associated with the event. In such examples, one or more event details of the multiple event details may include personal identification information associated with the client. The multiple event details may include, for example, an address associated with the client, the client's age, the client's gender, a personal identification number associated with the client, a description of the event, a time of the event, and/or a location of the event. The selection of certain events may also automatically generate additional questions for the client to answer or request additional information or materials from the client that will be beneficial to the retention of the service process and the providing of quality service.

In some aspects, the online matching system generates a set of scrubbed event details comprising one or more event details of the multiple event details based on receiving the service request message. In such aspects, the personal identification information associated with the client may be unattainable from the set of scrubbed event details. Additionally, the online matching system may transmit the set of scrubbed event details to the service provider device and receive, from the service provider device associated with the service provider, a service proposal based on the set of scrubbed event details. The online matching system may then transmit, to the client device, the service proposal based on receiving the service proposal from the service provider, and also transmit, to the service provider device, the multiple event details based on receiving an acceptance message indicating acceptance of the service proposal. The acceptance message may be received based on transmitting the service proposal.

In some aspects, the service provider retention process of the invention can have features that further ensure normalization of service, including but not limited to, verification of service provider licensing and/or education (including licensing in a particular state or setting) and exclusion of unqualified providers; verification of the incident at issue and related appointments (including accessing a summons or court schedule and comparing it to the client-provided information for confirmation); updating event details provided by the client during the service retention process (including compiling additional information provided by the client with the original submission and noting inconsistencies when present); recovery of records pertinent to the event and representation (including public records relating to citing law enforcement officers, the prosecuting attorneys, and/or the presiding judge, and, with permission, client criminal, civil, medical, and/or financial records); and compiling feedback and statistics on service providers, rates and charges for the service, and client outcomes. Features of the service provider retention process also may include educational components, including but not limited to the option to obtain language translations, definitions, the text of applicable legal codes, or instructive examples that may assist the client in providing accurate information. All such additional features may be automated in full or in part based on the availability and accessibility of such information online, as reported in public records, or as reported by the service providers and/or clients.

Particular aspects of the subject matter described in this disclosure may be implemented to realize one or more of the following potential advantages. In some aspects, implicit and/or explicit biases in a service provider retention process may be reduced based on normalizing information provided to a service provider during the service provider retention process. In addition, normalizing the information mitigates potential violations of privacy laws and/or confidentiality laws.

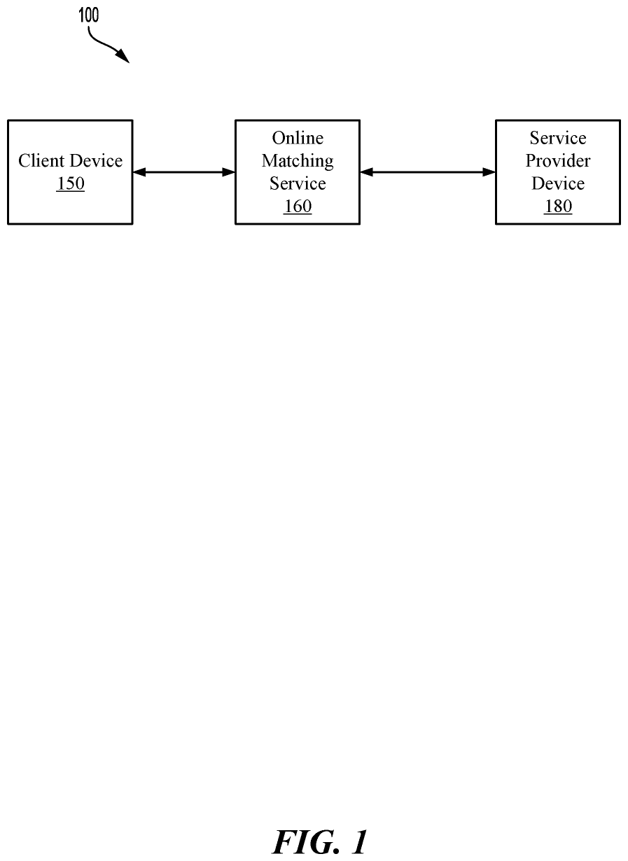

FIG. 1 is a block diagram illustrating an example 100 of a network architecture for a matching system, in accordance with aspects of the present disclosure. As shown in FIG. 1, a client device 150 used by a client may be in communication with an online matching service 160 over a network, such as the Internet. In the example of FIG. 1, the client associated with the client device 150 is in need of a service provider, such as an attorney. The online matching service 160 may be hosted on a server device (not shown in FIG. 1). The client may also be referred to as a customer or a subscriber. Additionally, as shown in FIG. 1, a service provider device 180 may also be in communication with the online matching service 160 over a network, such as the Internet. The service provider device 180 and the client device 150 may be any type of device with a network connection; such devices may include, but are not limited to, a personal computer, a smartphone, a tablet, or another type of network device.

As described, in some aspects of the present disclosure, the client associated with the client device 150 may use the online matching service 160 to retain the service provider associated with the service provider device 180. Aspects of the present disclosure are not limited to one service provider device 180 or one client device 150. In some examples, multiple service provider devices 180 and client devices 150 may access the online matching service 160, each device 180 and 150 may be associated with a different service provider and client, respectively.

In some examples, the online matching service 160 may be accessed via an Internet portal, such as a web page, or an application on the device 150 and 180. The online matching service 160 may receive analytics, reports, and/or other information from the application or web page to improve future matches.

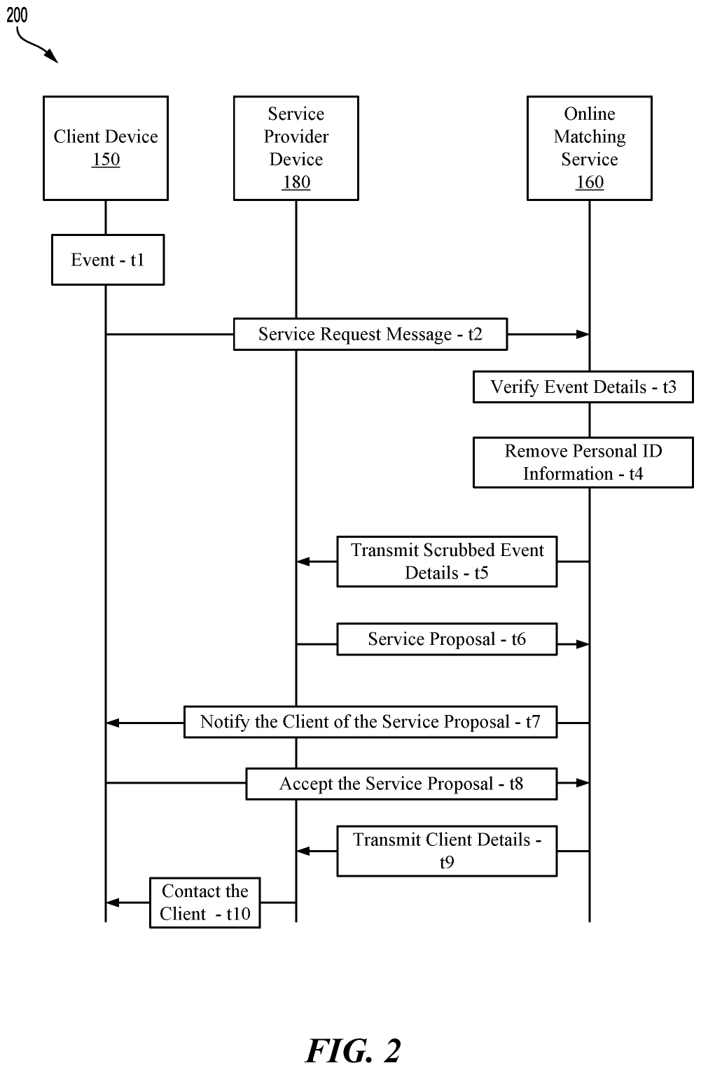

FIG. 2 is a timing diagram illustrating an example 200 of a process for matching a service provider and a client, in accordance with aspects of the present disclosure. As shown in the example 200 of FIG. 2, a client device 150, a service provider device 180, and an online matching service 160, as described with reference to FIG. 1, may be used in the process for matching the service provider and the client. As described, aspects of the present disclosure are not limited to one service provider device 180 or one client device 150. In some examples, multiple service provider devices 180 and client devices 150 may access the online matching service 160, each device 180 and 150 may be associated with a different service provider and client, respectively. For ease of explanation, the example of FIG. 2 is limited to one service provider device 180 and one client device 150.

As shown in FIG. 2, at time t1, an event may occur for a client associated with the client device 150. The event may be an incident that places the client in need of services provided by the service provider associated with the service provider device 180. For example, the services may be legal services and the event may be an alleged violation of a law. In this example, the event may also include receiving a court summons based on the alleged violation. In one example, the violation may be a traffic violation, such as exceeding a speed limit, or an arrest. The court summons may include one or more of a date of the alleged violation, a time of the alleged violation, a location of the alleged violation, a description of the alleged violation, a description of one or more law codes, a jurisdiction, or a court date. Aspects of the present disclosure are not limited to legal services, court summons, and traffic or criminal violations. Other types of services and incidents are contemplated.

Based on the event at time t1, the client may transmit a service request message at time t2. The service request message may indicate both a request for the service provider based on an occurrence of the event (time t1) and event details associated with the event. In some examples, one or more event details include personal identification information associated with the client. In some such examples, the event details may include an address associated with the client, the client's age, the client's gender, a personal identification number associated with the client, the client's description of the event, another person's description of the event, a time of the event, a location of the event, and/or other information.

In some examples, the client may input details of the event via a portal associated with the online matching service 160. As described, the portal may be a web page or an application. Additionally, the portal may be provided to the client via an interface of the client device 150. As an example, the portal may be displayed as a web page at the client device 150. In some aspects, the incident may be provided via a form provided at the portal. The form may include text fields, radio buttons, drop-down menus, and/or other types of input fields. In some examples, one or more form fields may be dynamically provided based on an input provided by a client. As an example, a first set of form fields may be provided if the event is a first type of event, such as a traffic violation, and a second set of form fields may be provided if the event is a second type of event, such as a non-traffic violation. In this example, the client may first indicate whether the event is a traffic violation or a non-traffic violation. Additionally, the form may display the first set of form fields or the second set of form fields based on the indication provided by the client.

In some examples, drop-down menus, radio buttons, and other types of input fields may reduce an amount of text specified for input by the client. In some such examples, drop-down menus and radio buttons may not require any text to be input by the client. Reducing an amount of text that is input by the client may reduce an amount of personal identification information provided by the client. As discussed, personal information, such as education level, race, gender, language abilities, or socio-economic background may be identifiable based on a person's writing style.

Additionally, or alternatively, the client may transmit a copy of a document associated with the event, such as summons to the online matching service 160. The copy of the document may be an image (e.g., digital copy) of the document. The image may be captured by a sensor, such as a camera, of the client device 150. In some examples, the document includes details of the incident. In some examples, the event details provided via the client device 150 and/or extracted from the document associated with the event may be stored at one or more devices associated with the online matching service 160.

In some examples, each event detail may be associated with one or more labels, such as a category, a field, notes, and a hidden flag. TABLE 1 is an example of labels that may be assigned to one or more event details of the multiple event details received in the service request message. As shown in TABLE 1, event details may be categorized as, for example, client account information, client incident information, and summons information. Each category may be associated with one or more fields. As an example, the client account information may include a name field, an email address field, and a phone number field. In some aspects, the event details corresponding to a particular field may be associated with the particular field upon receipt of the event details at the online matching service 160. In some examples, a trained machine learning model may extract each event detail from the multiple event details received in the service request message and associate the extracted event detail with a particular field. For example, each event detail corresponding to a client's name may be associated with the name field. Additionally, each event field may be associated with a hidden flag that may be used to indicate whether the event details associated with the field should be excluded from a set of scrubbed event details. An event detail may be excluded from the set of scrubbed event details if the hidden flag associated with the event detail is enabled (shown as “Y” in TABLE 1).

TABLE 1

| Category | Field | Hidden |
|---|---|---|
| Client Account Info | Name | Y |
| | Email Address | Y |
| | Phone Number | Y |
| Client Incident Info | State | |
| | Jurisdiction | |
| | Date of Incident | |
| Summons Info | Photo of Summons | Y |
| | Summons Type | |
| | Summons Date/Time | |
| | Summons Law Code/Section | |
| | Charge Description | |
| Personal Info | Name (as it appears on summons) | Y |

As shown in FIG. 2, at time t3, the online matching service 160 may verify the event details provided in the service request message. In some examples, the online matching service 160 may transmit a verification message to an information verification device (not shown in FIG. 2), where the verification message requests a set of verification details based on one or more event details included in the service request message. As an example, the information verification device may be a device associated with a government database or an information database. In one example, the information verification device may be associated with a court and the verification message requests information associated with the court summons identified in the service request message. The court summons may be requested based on one or more event details, such as the client's name and/or other identification information. In some examples, the information verification device may transmit the set of verification details based on receiving the verification message. Additionally, the online matching service 160 may verify one or more event details of the event details included in the service request message based on each verification detail of the set of verification details matching a respective event detail of the event details included in the service request message. As an example, the set of verification details may include a location of the event, a time of the event, a specific violation, a summons number, the client's name, and the client's date of birth. In this example, the online matching service 160 may compare the set of verification details with the event details included in the service request message. A positive comparison may result in a verification of the event details. The online matching service 160 may request additional information from a client if one or more event details do not match.

In the example of FIG. 2, at time t4, the online matching service 160 removes personal identification (ID) information from the event details includes in the service request message. In some examples, removing the personal identification information includes generating a set of scrubbed event details including one or more event details of the multiple event details included in the service request message. In some examples, the personal identification information associated with the client is unattainable from the set of scrubbed event details. In some such examples, personal identification information associated with the client may be excluded from the set of scrubbed event details. The personal identification information may include the client's name, an address associated with the client, the client's age, the client's gender, a personal identification number associated with the client (e.g., a driver's license number, social security number, etc.), and/or other types of personal identification information that may be associated with an implicit or explicit bias. In some examples, the online matching service 160 may include a personal identification information model (e.g., a trained artificial neural network) that is specified to identify and exclude personal identification information from the set of scrubbed event details. Additionally, or alternatively, as described with reference to TABLE 1, an event detail may be excluded from the set of scrubbed event details if a hidden flag associated with the event detail is enabled.

Additionally, or alternatively, the personal identification information may be excluded from the set of scrubbed event details by generating a narrative of the client's account of the event, where the client's account of the event is one of the multiple event details included in the service request message. As discussed, personal identification information may be determined, or assumed, based on elements of event details written by the client, the elements include, but are not limited to a writing style, language, or tone. Therefore, a narrative generated based on the event details written by the client, or other information written by the client, may remove, or reduce, the personal identification information. In some examples, the narrative may be generated by adjusting one or more of a writing style, a language, or tone of the client's account of the event. In some such examples, a trained writing model (e.g., a trained artificial neural network) may be used to generate the narrative based on the client's account of the event. As an example, the trained writing model may replace normalize each client's account of the event to a standard format, such that the respective client's account of the event use similar words, have a same language, and/or a same tone.

As shown in FIG. 2, at time t5, the scrubbed event details (e.g., the set of scrubbed event details) may be transmitted to a service provider device 180 to be displayed to the associated service provider. The scrubbed event details may be transmitted with a message indicating a request to provide services. As an example, the scrubbed event details may be transmitted in an electronic message (e.g., text message, email message, etc.) or transmitted when the service provider accesses a portal associated with the online matching service 160. Based on the scrubbed event details, the service provider may provide a service proposal, such as a bid, indicating a cost for providing services to handle the event. Alternatively, the service provider may ignore the scrubbed event details, deny an offer to provide servicers, or delete a message associated with the scrubbed event details. At time t7, based on receiving the service provider's proposal, the online matching service 160 may transmit the service provider's proposal to the client device 150. In the current example, the online matching service 160 may act as an intermediary between the client and the service provider to maintain the client's anonymity. In some examples, the client may accept the service provider's proposal received at time t7. The client may receive multiple proposals, where each proposal is associated with a different service provider. At time t8, the client device 150 may transmit a message to the online matching service indicating that the client has accepted the service proposal transmitted at time t7. Based on the client accepting the proposal, the online matching service 160 may transmit the client's details, including the personal identification information, to the service provider device 180 at time t9. The service provider associated with the service provider device 180 may review the client details and contact the client at time t10. In some example, the client details may include information associated with the client device, such as a phone number, fax number, and/or email address.

As discussed, various aspects of the present disclosure provide an automated online matching service for service providers, such as attorneys, and prospective clients to resolve various matters. In some examples, the automated online matching service may provide a fair system by removing biases associated with personally identifiable information (PII). Service request from multiple clients may be processed, validated, and provided to multiple service providers. The multiple service providers may provide proposals to one or more service requests of the multiple service requests. Additionally, by removing personal identification information, some aspects of the present disclosure provide a bidding system where service providers may bid on service requests without knowing an identity of client associated with the service request. By connecting service providers and prospective clients in this way, the service providers bid on specific circumstances, thereby reducing price gouging or denial of services based on irrelevant factors.

In some aspects, a service provider may request additional details from a client. In such aspects, the online matching service may still act as an intermediary to request additional information from the client. In some examples, the personal identification information may also be scrubbed from the additional details. In some examples, the additional details may be combined with the original information obtained from the client such that the full set of information can be transmitted as needed in the future.

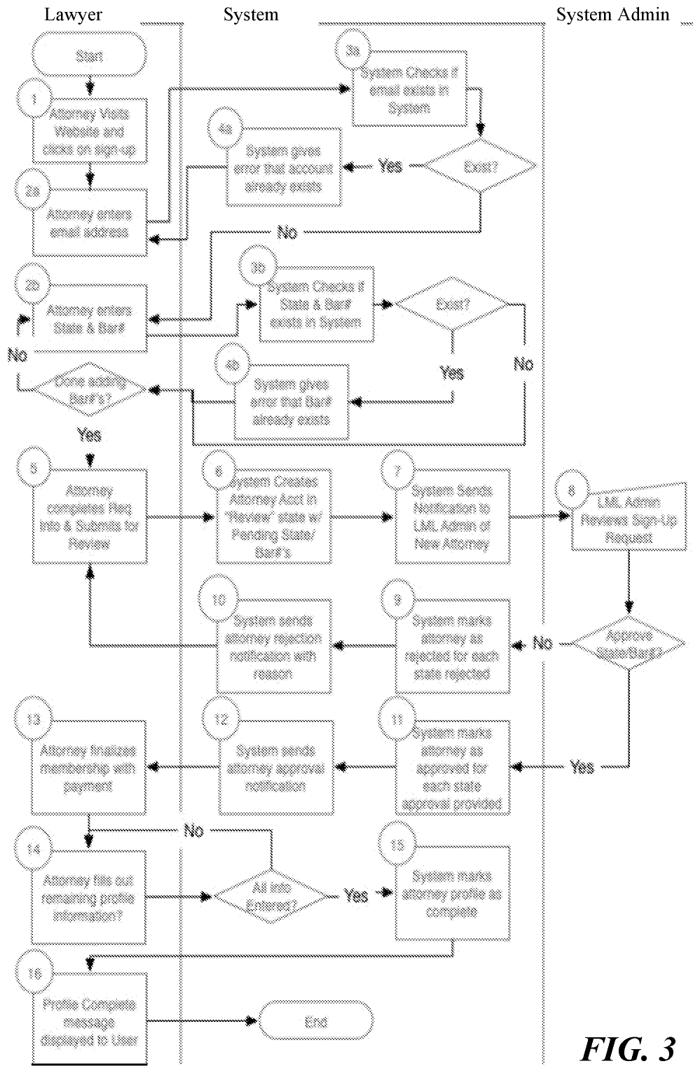

As discussed, a service request received from a client may be transmitted to multiple service providers, where each service provider may submit a proposal or ignore the service request. In some examples, each service provider is verified before receiving service requests. Additionally, the service requests may only be transmitted to service providers that provide a type of service associated with the service request, such as legal services. FIG. 3 is a flow diagram illustrating an example 300 of a process for registering a service provider at an online matching service, in accordance with aspects of the present disclosure. In the example 300 shown in FIG. 3, some blocks are associated with a system administrator (“system admin”). In some examples, the tasks associated with the system admin may be performed by a machine learning model trained to perform the noted tasks or a human. Additionally, the example 300 of FIG. 3 is based on a lawyer being a service provider. As discussed, aspects of the present disclosure are not limited to lawyers and legal events. Other types of service providers and events are contemplated. Furthermore, the system discussed in FIG. 3 may be an example of the online matching system 160 described with reference to FIGS. 1 and 2. The tasks associated with the online matching system 160 may be performed by one or more devices associated with the online matching system 160. The task associated with the service provider (e.g. lawyer) of FIG. 3 may be performed by a service provider device, such as a service provider device 180 described with reference to FIGS. 1 and 2.

TABLE 2 is an example of information that may be collected from each service provider during a registration process.

TABLE 2

| Category | Field | Notes |
|---|---|---|
| lawyer | State | |
| Information | | |
| | Bar Number | |
| | Bar License Card Upload | Encrypted |
| | Name | |
| | Email Address | |
| | Phone Number | |
| | Drivers License Upload | Encrypted |
| | Jurisdictions Desired | Can allow multiple |
| | | selections here. |
| | Meeting Contact Methods | List of Different Meeting |
| | | Contact Options (e.g., |
| | | in-person, phone call, |
| | | web conference, etc.) |
| | Website URL | |
| | Google My Business URL | |
| | Avvo URL | |
| | LinkedIn URL | |
| | About Me | |

In some examples, the service providers may be bound by local, state, and/or federal confidentiality rules. Therefore, in some aspects, the personal identification information may be scrubbed based on local regulations. That is, if the same client provides the same event details in two different jurisdictions, the scrubbed event details may be different in each jurisdiction if each jurisdiction is associated with different privacy and/or confidentiality regulations.

In some examples, the personal identification information may be privatized (e.g., scrubbed) on a per-service provider basis for service providers in a same jurisdiction. In such examples, the personal identification information may be privatized based on statistics associated with each service provider. The statistics may identify specific biases or trends associated with the service provider.

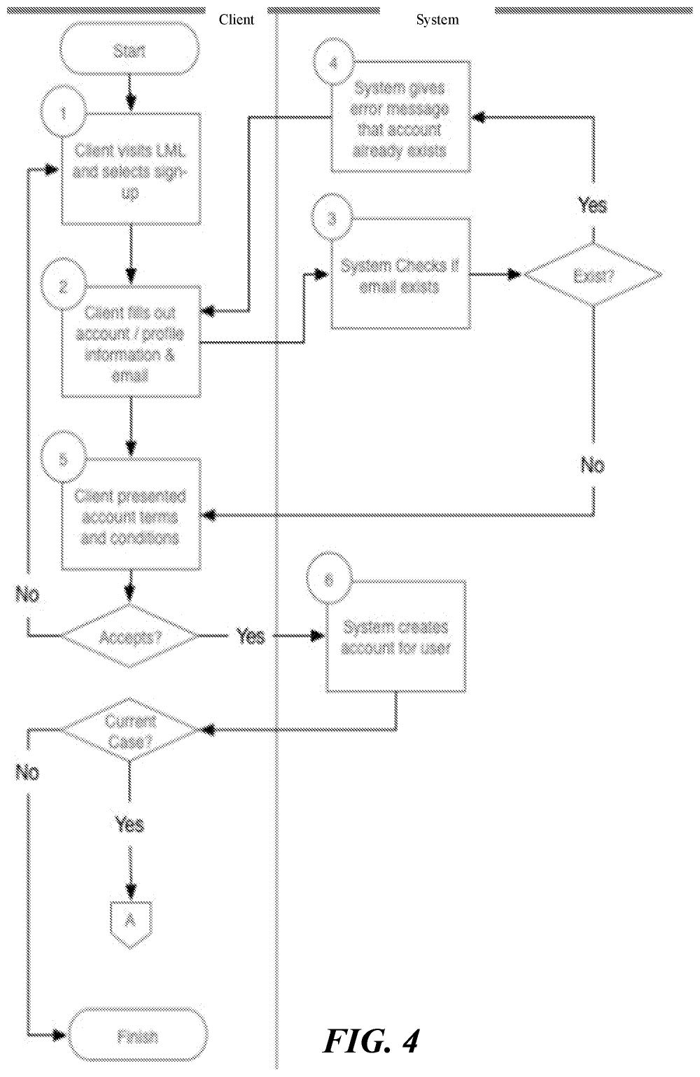

FIG. 4 is a flow diagram illustrating an example 400 of a process for registering a client at an online matching service, in accordance with aspects of the present disclosure. The system discussed in FIG. 4 may be an example of the online matching system 160 described with reference to FIGS. 1 and 2. The tasks associated with the online matching system 160 may be performed by one or more devices associated with the online matching system 160. The task associated with the client of FIG. 4 may be performed by a client device, such as a client device 150 described with reference to FIGS. 1 and 2.

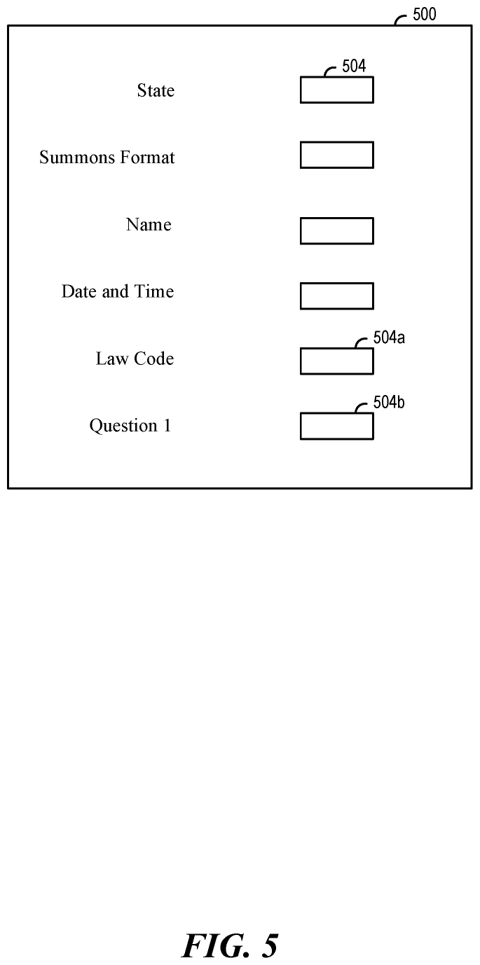

FIG. 5 is a block diagram illustrating an example of a portal 500 of an online matching service for providing incident details, in accordance with aspects of the present disclosure. As shown in FIG. 5, the portal 500 may include multiple fields 504 for providing details associated with the event. Each field 504 may be associated with a different category, such as State, Summons Format, Name, Data and Time, and Law Code. As discussed, each field 504 may be one of a free form text field, a drop down menu, a radio button, or another type of input field. For ease of explanation, the fields 504 of FIG. 5 are shown as free form text fields. In some examples, a field 504 may be a dynamic field 504b, where the category associated with the dynamic field 504b (shown as “Question 1”) may be adjusted based on an answer provided in another field, such as a law code field 504a.

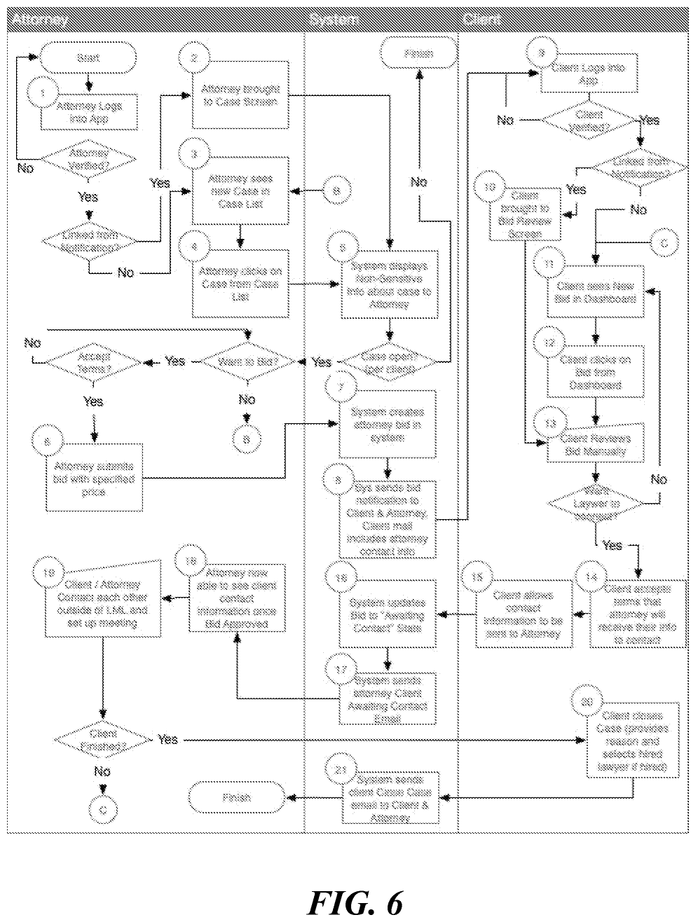

FIG. 6 is a block diagram illustrating an example 600 of a process for matching a client and a service provider based on privatized information, in accordance with aspects of the present disclosure. The example 600 of FIG. 6 is based on a lawyer being a service provider. As discussed, aspects of the present disclosure are not limited to lawyers and legal events. Other types of service providers and events are contemplated. Furthermore, the system discussed in FIG. 6 may be an example of the online matching system 160 described with reference to FIGS. 1 and 2. The tasks associated with the online matching system 160 may be performed by one or more devices associated with the online matching system 160. The task associated with the service provider (e.g. lawyer) of FIG. 6 may be performed by a service provider device, such as a service provider device 180 described with reference to FIGS. 1 and 2. The task associated with the client of FIG. 4 may be performed by a client device, such as a client device 150 described with reference to FIGS. 1 and 2.

In some aspects, a client and service provider may be bound to different terms and conditions. In some examples, a service provider may be bound to jurisdiction-specific terms and conditions. In some examples, each service provider may be periodically validated. For example, attorneys may be validated to ensure each attorney is in good standing with a local bar. As an example, the period may be once every thirty days. The validation may be autonomously performed based on information provided by credentialing entities, such as the state or local bar office.

As discussed, the scrubbed event details may be transmitted to a service provider. In some examples, additional information associated with an event may be transmitted before or after a client accepts a proposal based on a confidentiality associated with the additional information. In some examples, additional documents may be retrieved from public or private websites and transmitted with the client details or scrubbed event details. As an example, a client's driving record may be submitted to the service provider after the client accepts the proposal. As another example, pictures of an event may be retrieved from public sources and transmitted with the scrubbed event details if the pictures do not include personal identification information.

As discussed, some aspects of the present disclosure are directed to a service provider retention process that permits clients to securely obtain bids (e.g., service proposals) from one or more potential service providers. In some examples, a client may obtain a bid from one or more potential service providers based on event details provided to each one of the potential service providers. The event details may include client data, such as personal identification information.

Some aspects of the present disclosure also relate to systems for operating a matching service for clients and service providers. Such systems may include, but are not limited to, systems that operate on mobile devices, handsets, and/or through web applications. In some implementations, the system improves a speed for retaining a service provider, such as an attorney. Improving the service provider speed may reduce missed deadlines and may also provide assistance in emergency situations.

As discussed, some aspects of the present disclosure are directed to managing and protecting privileged and confidential information, including safeguards to prevent misuse by service providers (e.g., attorneys) and/or the providers of the matching service. As an example, the matching system may specify that bidding attorneys agree to state bar requirements on the use of confidential and privileged information before such information is shared with the bidding attorney. In some aspects, an attorney's access to information may be limited if such access may create biases about the case or the client prematurely. Limiting access to such information may improve pricing fairness.

In some aspects, the matching system may provide information associated with the service provider to the client as well as facilitating meetings with service providers that the client selects for further review and possible retention. Certain safeguards may be established as part of the service as well. The matching system could, for example, track statistical information regarding the attorney's court appearances and case outcomes. In some examples, the matching system may autonomously access court and public records to assist the client in filing the request for services.

As discussed, aspects of the present disclosure may prevent the service providers from accessing and disclosing privileged information and/or being subject to other regulatory obligations, such as those relating to trust accounts, advertising, or the like.

In some aspects, a client may submit an event that is not associated with any formal documents, such as a summons. In some other aspects, one party that is not associated with an event may submit a service provider request for another party. As an example, a parent may submit a service provider request for their child. In such an example, the child may be incapable of submitting the request due to an inability to access the Internet.

In some examples, event details may be autonomously populated based on a data connection between the online search system and an appropriate database. In such examples, the client may provide one or more event details and other details may be populated based on information pulled from a database associated with the event.

In some examples, an average price for a service proposal may be included in the service proposal transmitted to the client. In such examples, the client may determine whether the service proposal is fair or biased.

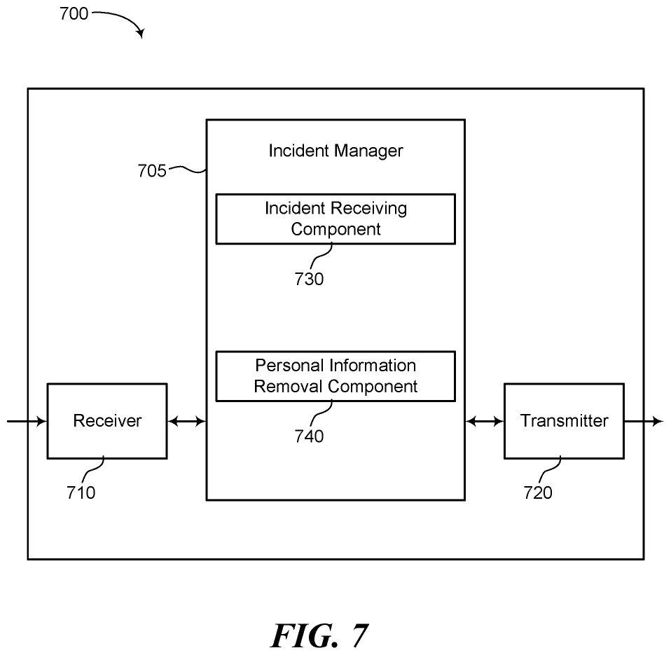

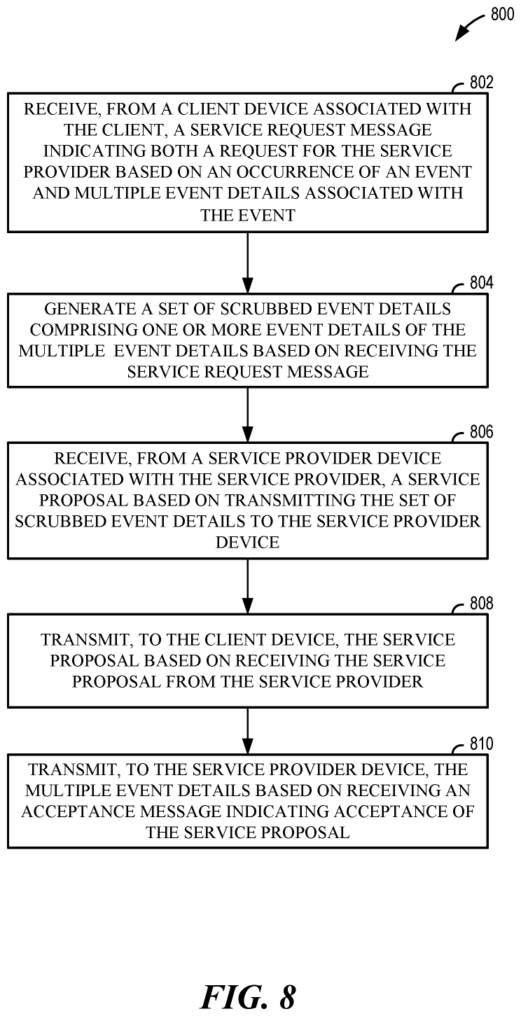

FIG. 7 is a block diagram illustrating an example of a communication device 700 that supports privatizing personal information in an online matching system, in accordance with various aspects of the present disclosure. The device 700 may be an example of aspects of a device associated with an online matching service 160 described with reference to FIGS. 1 and 2. The communication device 700 may include a receiver 710, an incident manager 705, a transmitter 720, an event receiving component 730, and a personal information removal component 740, which may be in communication with one another (for example, via one or more buses). In some examples, the communication device 700 is configured to perform operations including operations of the process 800 described below with reference to FIG. 8. Additionally, or alternatively, the averages may be provided to the service provider. In some examples, the averages may be location-based In other examples, the averages may be based on all service providers or a subset of service provider proposals. Aspects are not limited to averages. Other functions are contemplated, such as a medium of the service provider proposals.

In some examples, the communication device 700 may communicate via a wireless and/or a wired connection. Additionally, the communication device 700 can include a chip, chipset, package, or device that includes one or more processors and one or more modems (for example, a 5G modem or other cellular modem). In some examples, the incident manager 705, or its sub-components, may be separate and distinct components. In some examples, at least some components of the incident manager 705 are implemented as software stored in a memory. For example, portions of one or more of the components of the incident manager 705 can be implemented as non-transitory code executable by the processor to perform the functions or operations of the respective component.

The receiver 710 may receive data information, such as in the form of packets, from one or more other communication devices via various channels. The other communication devices may include, but are not limited to, a client device 150 and a service provider device 180 described with reference to FIGS. 1 and 2. The received information may be passed on to other components of the device 700.

The transmitter 720 may transmit signals generated by the incident manager 705 or other components of the communication device 700. In some examples, the transmitter 720 may be collocated with the receiver 710 in a transceiver.

The incident manager 705 may be an example of aspects of a processor. The incident manager 705 may include the event receiving component 730 and a personal information removal component 740. In some examples, working in conjunction with the receiver 710, the event receiving component 730 receives, from a client device associated with the client, a service request message indicating both a request for the service provider based on an occurrence of an event and multiple event details associated with the event. In some examples, one or more event details of the multiple event details may include personal identification information associated with the client. Additionally, working in conjunction with the event receiving component 730, the personal information removal component 740 may generate a set of scrubbed event details comprising one or more event details of the multiple event details based on receiving the service request message. In some examples, the personal identification information associated with the client may be unattainable from the set of scrubbed event details.

Additionally, working in conjunction with the transmitter 720 and one or both of the event receiving component 730 or the personal information removal component 740, the incident manager 705 may transmitting the set of scrubbed event details to the service provider device. Working in conjunction with the receiver 710 and one or both of the event receiving component 730 or the personal information removal component 740, the incident manager 705 may receive, from a service provider device associated with the service provider, a service proposal based on transmitting the set of scrubbed event details to the service provider device. Additionally, working in conjunction with the transmitter 720 and one or both of the event receiving component 730 or the personal information removal component 740, the incident manager 705 may transmit, to the client device, the service proposal based on receiving the service proposal from the service provider, and also transmit, to the service provider device, the number of event details based on receiving an acceptance message indicating acceptance of the service proposal. In some examples, the acceptance message may be received at the incident manager 705 based on the transmitted service proposal.

FIG. 8 is a flow diagram illustrating an example process 800 performed, for example by a communication device that supports privatizing personal information in an online matching system, in accordance with various aspects of the present disclosure. The example process 900 is an example of receiving information associated with an incident and privatizing the information for an online matching system, in accordance with various aspects of the present disclosure. The operations of the process 900 may be implemented by a device associated with an online matching system 160, or its components, described with reference to FIGS. 1 and 2. For example, operations of the process 900 may be performed by one or more of the incident manager 705, the transmitter, 720 the receiver 710, the incident receiving component 730, or the personal information removal component 740, as described with reference to FIG. 7. In some examples, a device associated with an online matching system 160 may execute a set of instructions to control the functional elements of the device to perform the operations or functions described below. Additionally, or alternatively, a device associated with an online matching system 160 may perform aspects of the operations or functions described below using special-purpose hardware.

As shown in FIG. 8, the process 800 begins at block 802, by receiving, from a client device associated with the client, a service request message indicating both a request for the service provider based on an occurrence of an event and multiple event details associated with the event. In some examples, one or more event details of the multiple event details may include personal identification information associated with the client. At block 804, the process 800 generates a set of scrubbed event details comprising one or more event details of the multiple event details based on receiving the service request message. In some examples, the personal identification information associated with the client may be unattainable from the set of scrubbed event details. At block 806, the process 800 receives, from a service provider device associated with the service provider, a service proposal based on transmitting the set of scrubbed event details to the service provider device. At block 808, the process 800 transmits, to the client device, the service proposal based on receiving the service proposal from the service provider. At block 810, the process 800 transmits, to the service provider device, multiple event details based on receiving an acceptance message indicating acceptance of the service proposal, the acceptance message being received based on transmitting the service proposal.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, or a combination of hardware and software. As used, a processor is implemented in hardware, firmware, or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, or the like.

It will be apparent that systems or methods described may be implemented in different forms of hardware, firmware, or a combination of hardware and software. The actual specialized control hardware or software code used to implement these systems or methods is not limiting of the aspects. Thus, the operation and behavior of the systems or methods were described without reference to specific software code—it being understood that software and hardware can be designed to implement the systems or methods based, at least in part, on the description.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, or the like), and may be used interchangeably with “one or more.” Where only one item is intended, the phrase “only one” or similar language is used. Also, as used, the terms “has,” “have,” “having,” or the like are intended to be open-ended terms. Further, the phrase “based on” is intended to mean “based, at least in part, on” unless explicitly stated otherwise.

As used, “or” is used intended to be interpreted in the inclusive sense, unless otherwise explicitly indicated. For example, “a or b” may include a only, b only, or a combination of a and b. As used, a phrase referring to “at least one of” or “one or more of” a list of items refers to any combination of those items, including single members. For example, “at least one of: a, b, or c” is intended to cover the examples of: a only, b only, c only, a combination of a and b, a combination of a and c, a combination of b and c, and a combination of a and b and c.

What is claimed is:

1. A method of matching a client and a service provider by an online matching system, comprising:
receiving, from a client device associated with the client, a service request message indicating both a request for the service provider based on an occurrence of an event and a plurality of event details associated with the event, one or more event details of the plurality of event details comprising personal identification information associated with the client;
generating a set of scrubbed event details comprising one or more event details of the plurality of event details based on receiving the service request message, the personal identification information associated with the client being unattainable from the set of scrubbed event details;
receiving, from a service provider device associated with the service provider, a service proposal based on transmitting the set of scrubbed event details to the service provider device;
transmitting, to the client device, the service proposal based on receiving the service proposal from the service provider;
transmitting, to the service provider device, the plurality of event details based on receiving an acceptance message indicating acceptance of the service proposal, the acceptance message being received based on transmitting the service proposal.

2. The method of claim 1, further comprising:
transmitting, to an information verification device, a verification message requesting a set of verification details based on one or more event details of the plurality of event details;
receiving, from the information verification device, the set of verification details based on transmitting the verification message; and
verifying one or more event details of the plurality of event details based on each verification detail of the set of verification details matching a respective event detail of the plurality of event details.

3. The method of claim 1, wherein the plurality of event details comprise two or more of the client's name, an address associated with the client, the client's age, the client's gender, a personal identification number associated with the client, a description of the event, a time of the event, a location of the event.

4. The method of claim 3, wherein a set of event details of the plurality of event details are included in an image of a document received based on the event, and
the method further comprises extracting the set of event details from the image of the document.

5. The method of claim 4, wherein:
the document is a court summons;
the service provider is an attorney; and
the event is a violation of a law.

6. The method of claim 1, wherein one or more event details of the plurality of event details comprising the personal identification information are excluded from the set of scrubbed event details.

7. The method of claim 6, wherein the personal identification information excluded from the set of scrubbed event details is associated with one or more of the client's name, an address associated with the client, the client's age, the client's gender, or a personal identification number associated with the client.

8. The method of claim 1, further comprising generating a narrative of the client's account of the event, wherein:
the client's account of the event is one of the plurality of event details, and
the set of scrubbed event details include the narrative.

9. The method of claim 8, further comprising modifying one or more of a writing style, a language, or tone associated with the client's account of the event,
wherein the narrative is based on the modified client's account of the event.

10. An apparatus for matching a client and a service provider at an online matching system, the apparatus comprising:
a processor;
a memory coupled with the processor; and
instructions stored in the memory and operable, when executed by the processor, to cause the apparatus to:
receive, from a client device associated with the client, a service request message indicating both a request for the service provider based on an occurrence of an event and a plurality of event details associated with the event, one or more event details of the plurality of event details comprising personal identification information associated with the client;
generate a set of scrubbed event details comprising one or more event details of the plurality of event details based on receiving the service request message, the personal identification information associated with the client being unattainable from the set of scrubbed event details;
receive, from a service provider device associated with the service provider, a service proposal based on transmitting the set of scrubbed event details to the service provider device;
transmit, to the client device, the service proposal based on receiving the service proposal from the service provider;
transmit, to the service provider device, the plurality of event details based on receiving an acceptance message indicating acceptance of the service proposal, the acceptance message being received based on transmitting the service proposal.

11. The apparatus of claim 10, wherein execution of the instructions further cause the apparatus to:
transmit to an information verification device, a verification message requesting a set of verification details based on one or more event details of the plurality of event details;
receive, from the information verification device, the set of verification details based on transmitting the verification message; and
verify one or more event details of the plurality of event details based on each verification detail of the set of verification details matching a respective event detail of the plurality of event details.

12. The apparatus of claim 10, wherein the plurality of event details comprise two or more of the client's name, an address associated with the client, the client's age, the client's gender, a personal identification number associated with the client, a description of the event, a time of the event, a location of the event.

13. The apparatus of claim 12, wherein: a set of event details of the plurality of event details are included in an image of a document received based on the event; and
execution of the instructions further cause the apparatus to extract the set of event details from the image of the document.

14. The apparatus of claim 13, wherein:
the document is a court summons;
the service provider is an attorney; and
the event is a violation of a law.

15. The apparatus of claim 10, wherein one or more event details of the plurality of event details comprising the personal identification information are excluded from the set of scrubbed event details.

16. The apparatus of claim 15, wherein the personal identification information excluded from the set of scrubbed event details is associated with one or more of the client's name, an address associated with the client, the client's age, the client's gender, or a personal identification number associated with the client.

17. The apparatus of claim 10, wherein:
execution of the instructions further cause the apparatus to generate a narrative of the client's account of the event;
the client's account of the event is one of the plurality of event details; and
the set of scrubbed event details include the narrative.

18. The apparatus of claim 17, wherein:
execution of the instructions further cause the apparatus to modify one or more of a writing style, a language, or tone associated with the client's account of the event; and
the narrative is based on the modified client's account of the event.

19. A non-transitory computer-readable medium having program code recorded thereon for matching a client and a service provider at an online matching system, the program code executed by a processor and comprising:
program code to receive, from a client device associated with the client, a service request message indicating both a request for the service provider based on an occurrence of an event and a plurality of event details associated with the event, one or more event details of the plurality of event details comprising personal identification information associated with the client;
program code to generate a set of scrubbed event details comprising one or more event details of the plurality of event details based on receiving the service request message, the personal identification information associated with the client being unattainable from the set of scrubbed event details;
program code to receive, from a service provider device associated with the service provider, a service proposal based on transmitting the set of scrubbed event details to the service provider device;
program code to transmit, to the client device, the service proposal based on receiving the service proposal from the service provider;
program code to transmit, to the service provider device, the plurality of event details based on receiving an acceptance message indicating acceptance of the service proposal, the acceptance message being received based on transmitting the service proposal.

20. The non-transitory computer-readable medium of claim 19, wherein the plurality of event details comprise two or more of the client's name, an address associated with the client, the client's age, the client's gender, a personal identification number associated with the client, a description of the event, a time of the event, a location of the event.
